(19) United States
(12) Patent Application Publication
(10) Pub. No.: US 2014/0216574 A1
(43) Pub. Date: Aug. 7, 2014

(54) RELIEF VALVE

(71) Applicant: DENSO CORPORATION, Kariya-city (JP)

(72) Inventor: Hirofumi Onodera, Kariya-city (JP)

(73) Assignee: DENSO CORPORATION, Kariya-city (JP)

(21) Appl. No.: 14/084,706

(22) Filed: Nov. 20, 2013

(30) Foreign Application Priority Data
Feb. 1, 2013 (JP) 2013-18114

(51) Int. Cl. F16K 17/19; F16K 25/00

(52) U.S. Cl. CPC F16K 17/19; F16K 25/00
USPC 137/512; 137/528

(57) ABSTRACT

A relief valve includes a valve element and a seal lip. The valve element is configured to open and close a hole, which communicates with a pressure chamber, according to a pressure in the pressure chamber into which fluid is introduced. The seal lip is in an annular shape and equipped to the valve element. The seal lip is configured to be in contact tightly with a valve seat, which surrounds the hole, when being in a valve-close state. The seal lip is inclined toward an inner circumferential periphery of the hole and projected from the valve element toward the valve seat.

### CROSS REFERENCE TO RELATED APPLICATION

This application is based on reference Japanese Patent Application No. 2013-18114 filed on Feb. 1, 2013, the disclosure of which is incorporated herein by reference.

### TECHNICAL FIELD

The present disclosure relates to a relief valve configured to maintain a pressure in a space within a proper pressure range. For example, the present disclosure relates to a relief valve device used for a sealing valve for a fuel tank.

### BACKGROUND

For example, Patent Document 1 discloses a conventional relief valve device employed as a sealing valve for a fuel tank. The relief valve device includes a positive-pressure relief valve and a negative-pressure relief valve in order to maintain a pressure in a fuel tank at an appropriate pressure.

Pressure in a fuel tank may become a positive pressure as fuel evaporates and may become a negative pressure as vaporized fuel is liquefied. In consideration of this, a positive-pressure relief valve and a negative-pressure relief valve are equipped in order to maintain a pressure in a fuel tank at an appropriate pressure thereby to protect the fuel tank.

Each of the relief valves includes a valve element and a seal lip. The valve element is configured to open and close a hole. The hole communicates with a pressure chamber connected to the fuel tank. The hole is surrounded by a valve seat. The seal lip is equipped to the valve element and configured to make contact tightly with the valve seat when being in a valve-close state.

FIG. 6 shows a conventional seal lip having a tip end and a root. The root is close to a valve element. The tip end is farther from the valve element than the root. The tip end is projected and inclined to be located on the outer circumferential periphery. When being in the valve-close state, the seal lip receives a force from a relief spring to deform elastically thereby to make contact tightly with the valve seat. That is, the seal lip is required to deform easily to some extent to produce a secure sealing property of the seal lip.

(Patent Document 1)

Publication of Unexamined Japanese Patent Application No. 2013-15208

It is noted that, the following concern may arise in an assumed configuration in which the seal lip is configured to deform easily. Specifically, as shown in FIG. 6, when being in the valve-close state, pressure is exerted from a pressure chamber to expand the seal lip 102 radially outward. Consequently, as shown by the two-dot chain line in the assumed configuration, a seal portion 102a, which is a tip end of the seal lip 102, may be deformed away from a valve seat 104 to cause pressure leakage. That is, the assumed configuration may cause pressure leakage before the pressure becomes a valve open pressure.

### SUMMARY

It is an object of the present disclosure to produce a relief valve configured to restrict pressure leakage when being in a valve-close state.

According to an aspect of the present disclosure, a relief valve comprises a valve element configured to open and close a hole, which communicates with a pressure chamber, according to a pressure in the pressure chamber. The pressure chamber is configured to receive fluid. The relief valve further comprises a seal lip being in an annular shape and equipped to the valve element. The seal lip is configured to be in contact tightly with a valve seat, which surrounds the hole, when being in a valve-close state. The seal lip is inclined toward an inner circumferential periphery of the hole and projected from the valve element toward the valve seat.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram showing a tank sealing valve equipped with a relief valve device according to a first embodiment of the present disclosure;

FIG. 2 is a sectional view showing the tank sealing valve according to the first embodiment;

FIG. 3 is a sectional view showing the relief valve device according to the first embodiment;

FIG. 4 is an enlarged view showing a positive-pressure relief valve of the relief valve device according to the first embodiment;

FIG. 5 is an enlarged view showing a negative-pressure relief valve of the relief valve device according to the first embodiment; and

FIG. 6 is an enlarged view showing a conventional relief valve according to a prior art.

### DETAILED DESCRIPTION

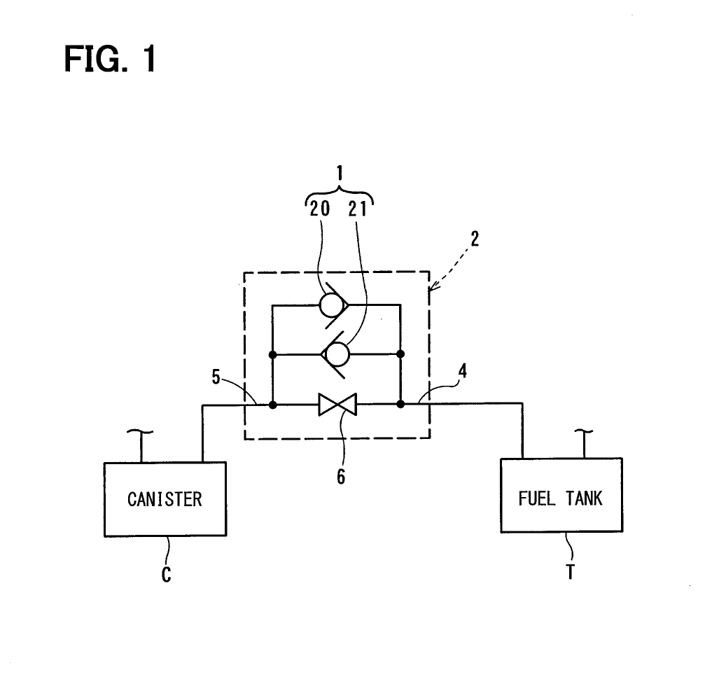

As follows, an embodiment of the present disclosure will be described with reference to FIGS. 1 to 5.

### Embodiment

### Configuration of Embodiment

The embodiment will be described with reference to FIGS. 1 to 5.

A relief valve device 1 according to the present embodiment is used for, for example, a tank sealing valve 2 of an evaporated fuel regulation apparatus.

As shown in FIG. 1, the tank sealing valve 2 is connected with an intermediate portion of a pipe, which communicates a fuel tank T (pressure vessel) with a canister C. The fuel tank T stores fuel such as gasoline. The canister C absorbs evaporated fuel.

The tank sealing valve 2 includes a first port 4, a second port 5, a solenoid valve 6, and a relief valve device 1. The first port 4 is connected to the fuel tank T. The second port 5 is connected to the canister C. The solenoid valve 6 is configured to open and close a passage between the first port 4 and the second port 5. The relief valve device 1 is configured to open and close passages between the first port 4 and the second port 5 according to a pressure state in the fuel tank T.

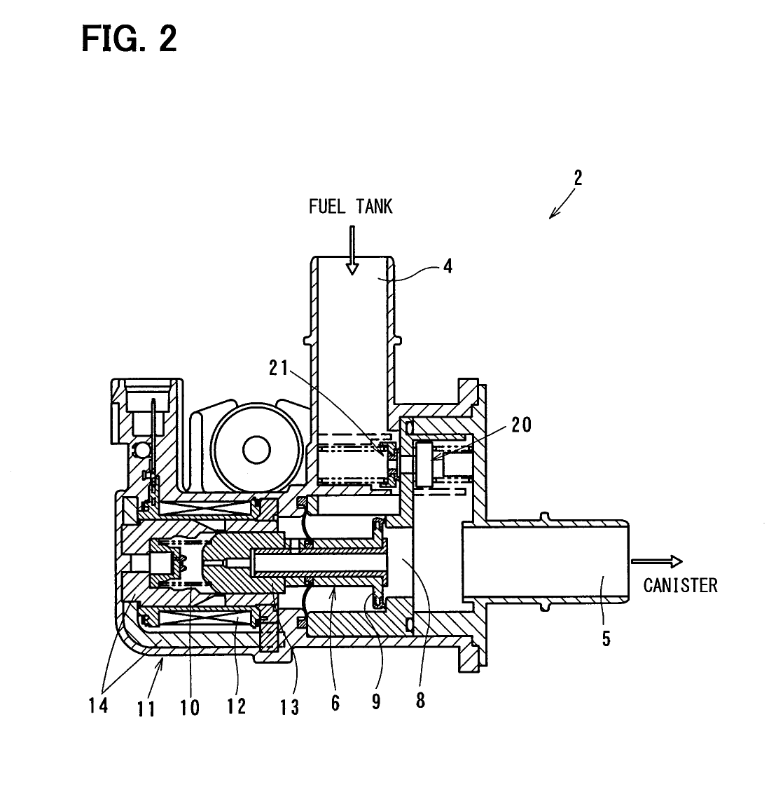

As shown in FIG. 2, the solenoid valve 6 includes a valve element 9, a return spring 10, and a solenoid actuator 11. The valve element 9 is configured to open and close a valve hole 8, which is equipped between the first port 4 and the second port 5. The return spring 10 biases the valve element 9 in a valve-close direction. The solenoid actuator 11 is configured to manipulate the valve element 9 against a biasing force of the return spring 10. The solenoid actuator 11 includes, for example, a coil 12, a movable element 13, and a stator element 14. The coil 12 produces a magnetism when supplied with electricity. The movable element 13 is movable integrally with the valve element 9. The stator element 14 is configured to magnetically attract the movable element 13 by utilizing a magnetic force produced by the coil 12.

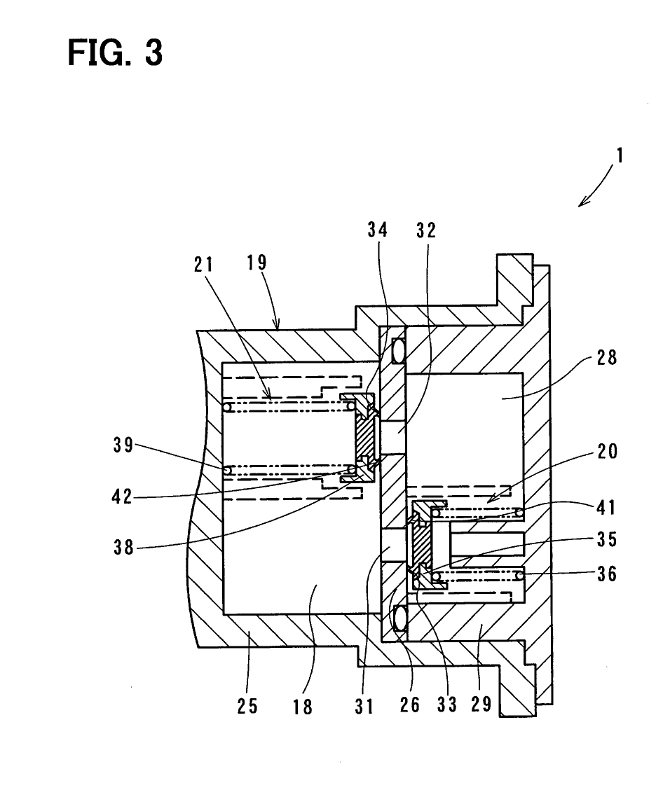

As shown in FIG. 3, the relief valve device 1 includes a housing 19, a positive-pressure relief valve 20, and a negative-pressure relief valve 21. The housing 19 has a pressure chamber 18 communicated with the first port 4. The positive-pressure relief valve 20 is configured to open when a pressure in the pressure chamber 18 increases to a pressure equal to or greater than a valve opening pressure on a positive-pressure side. The negative-pressure relief valve 21 is configured to open when the pressure in the pressure chamber 18 decreases to a pressure less than the valve opening pressure on a negative-pressure side.

The housing 19 includes a housing main body 25, a valve plate 26, and a cover 29. The housing main body 25 is in a bottomed tubular shape and has an opening in one end. The valve plate 26 is equipped in the housing main body 25 to partition one side of the pressure chamber 18. The cover 29 is attached to block the opening of the housing main body 25 in the one end. The cover 29 forms a space 28 on the opposite side from the pressure chamber 18 through the valve plate 26. The housing 19 has an opening (not shown), which communicates the first port 4 with the pressure chamber 18. The housing 19 further has an opening (not shown), which communicates the second port 5 with the space 28.

The valve plate 26 has a first valve hole 31 and a second valve hole 32, each of which is configured to communicate the pressure chamber 18 with the space 28. In the present embodiment, each of the valve hole 31 and the valve hole 32 is formed as an aperture extending through the valve plate 26. A valve seat 33 is formed around an outer circumferential periphery of the valve hole 31 on a surface of the valve plate 26 on the opposite side from the pressure chamber 18. A valve seat 34 is formed around an outer circumferential periphery of the valve hole 32 on a surface of the valve plate 26 on the side of the pressure chamber 18.

The positive-pressure relief valve 20 is located on the opposite side from the pressure chamber 18 through the valve plate 26. The positive-pressure relief valve 20 includes a valve element 35 and a positive-pressure spring 36. The valve element 35 is configured to open the valve hole 31 when being lifted from the valve seat 33 and to close the valve hole 31 when being seated on the valve seat 33. The positive-pressure spring 36 biases the valve element 35 in a close direction. The positive-pressure spring 36 defines the valve opening pressure on the positive-pressure side. When a pressure in the pressure chamber 18 increases to a pressure equal to or greater than the valve opening pressure on the positive-pressure side, the first valve hole 31 is opened.

The negative-pressure relief valve 21 includes a valve element 38 and a negative-pressure spring 39. The valve element 38 is configured to open the valve hole 32 when being lifted from the valve seat 34 and to close the valve hole 32 when being seated on the valve seat 34. The negative-pressure spring 39 biases the valve element 38 in a close direction. The negative-pressure spring 39 defines the valve opening pressure on the negative-pressure side. When a pressure in the pressure chamber 18 decreases to a pressure less than the valve opening pressure on the negative-pressure side, the negative valve hole 32 is opened.

### Feature of Embodiment

The valve element 35 has a seal lip 41 in an annular shape. When being in a valve-close state, the seal lip 41 is configured to be in contact tightly with the valve seat 33, which surrounds the valve hole 31. The valve element 38 has a seal lip 42 in an annular shape. When being in a valve-close state, the seal lip 42 is configured to be in contact tightly with the valve seat 34, which surrounds the valve hole 32.

The seal lip 41 is formed of, for example, rubber. When being in the valve-close state, the seal lip 41 is elastically deformed by application of the biasing force from the positive-pressure spring 36 to be in contact tightly with the valve seat 33.

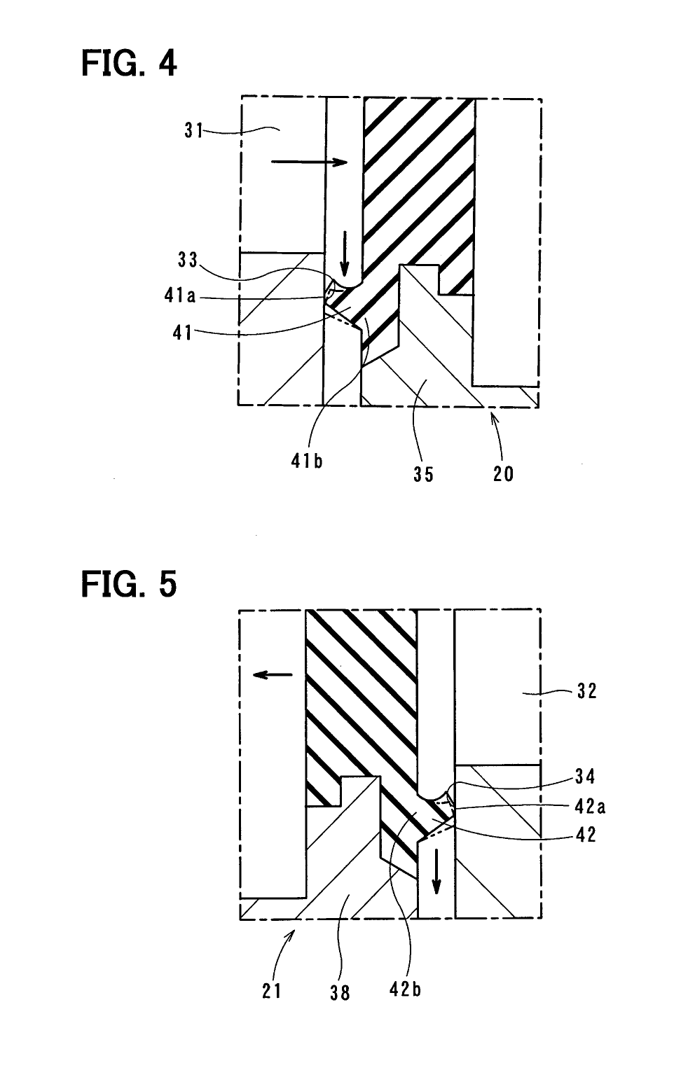

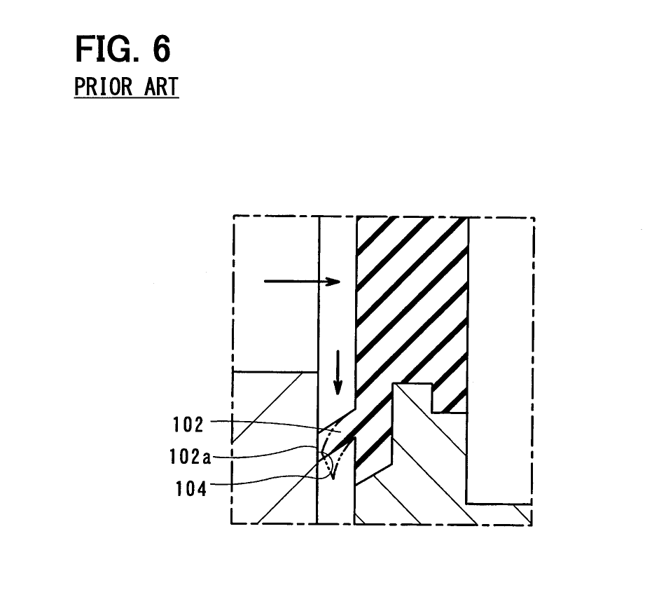

More specifically, as shown in FIG. 4, the seal lip 41 has a seal portion 41a and a root portion 41b. The seal portion 41a is located at a tip end of the seal lip 41. The root portion 41b is located close to the valve element 35. The seal portion 41a is configured to be in contact with the valve seat 33. The seal portion 41a is located on a radially inner side relative to the root portion 41 b to form an inward-directed lip.

The seal lip 42 is formed of, for example, rubber. When being in the valve-close state, the seal lip 42 is elastically deformed by application of the biasing force from the negative-pressure spring 39 to be in contact tightly with the valve seat 34.

More specifically, as shown in FIG. 5, the seal lip 42 has a seal portion 42a and a root portion 42b. The seal portion 42a is located at a tip end of the seal lip 42. The root portion 42b is located close to the valve element 38. The seal portion 42a is configured to be in contact with the valve seat 34. The seal portion 42a is located on a radially inner side relative to the root portion 42b to form an inward-directed lip.

The seal lip 41 is designed such that the root portion 41b has a high rigidity to enable only the seal portion 41a to seal the valve seat 33. Similarly, the seal lip 42 is designed such that the root portion 42b has a high rigidity to enable only the seal portion 42a to seal the valve seat 34. The configuration of the present embodiment is produced in view of the following issues. Specifically, assuming a configuration, in which the root portions 41b and 42b are configured to be easily bent, a region from the seal portion 41a to a portion around the root portion 41b may be entirely in contact with the valve seat 33. In the present assumed configuration, a region from the seal portion 42a to a portion around the root portion 42b may be entirely in contact with the valve seat 34, similarly. The present assumed configuration may have a small and insufficient sealing surface pressure.

### Operation of Relief Valve Device

When a positive pressure greater than the valve opening pressure of the positive-pressure relief valve 20 occurs in the fuel tank T, the valve element 35 opens the valve hole 31. Consequently, fluid flows from the first port 4 on the side of the fuel tank T through the pressure chamber 18, the valve hole 31, and the space 28, to the second port 5 on the side of the canister C. Thus, a pressure in the fuel tank T can be reduced.

Alternatively, when a negative pressure greater than the valve opening pressure of the negative-pressure relief valve 21 occurs in the fuel tank T, the valve element 35 opens the valve hole 32. Consequently, fluid flows from the second port 5 on the side of the canister C through the space 28, the valve hole 32, and the pressure chamber 18 to the first port 4 on the side of the fuel tank T. Thus, a pressure in the fuel tank T can be increased.

### Operation Effect of Embodiment

Subsequently, an operation effect of the present embodiment and a behavior of the seal lips 41 and 42 in the valve-close state relative to a pressure exerted from the pressure chamber will be described with reference to FIGS. 4 and 5.

As shown in FIG. 4, the positive-pressure relief valve 20 is in the valve-close state. In the present state, the valve element 35 is depressed from the positive-pressure spring 36 and closed. Further, the seal portion 41a is in contact with the valve seat 33 at the seal lip 41, thereby to produce a secure sealing configuration.

In the present valve-close state, when a positive pressure occurs in the pressure chamber 18 (FIG. 3), the positive pressure works to expand the seal lip 41 outward. When the seal lip 41 tends to expand outward, as shown by the two-dot chain line in FIG. 4, the seal lip 41 deforms in a direction to reduce its inclination angle. That is, the seal lip 41 tends to rise. The present configuration enables the seal portion 41a to be pressed onto the valve seat 33 and to keep the seal portion 41a in contact with the valve seat 33. Thus, the present configuration enables to restrict pressure from leaking at a positive pressure less than the valve opening pressure.

In the present state, a positive pressure in the pressure chamber 18 also works onto the seal lip 42 of the negative-pressure relief valve 21. It is noted that, the positive pressure works in a direction to depress the valve element 35 to be seated on the valve seat 33. Therefore, the sealing property of the negative-pressure relief valve 21 can be secured, regardless of deformation of the seal lip 42.

In addition, as shown in FIG. 5, the negative-pressure relief valve 21 is in the valve-close state. In the present state, the valve element 38 is depressed from the negative-pressure spring 39 and closed. Further, the seal lip 42 is in contact with the valve seat 34 at the seal portion 42a, thereby to produce a secure sealing configuration.

In the present valve-close state, when a negative pressure occurs in the pressure chamber 18 (FIG. 3), the negative pressure works to expand the seal lip 42 outward. When the seal lip 42 tends to expand outward, as shown by the two-dot chain line in FIG. 5, the seal lip 42 deforms in a direction to reduce its inclination angle. That is, the seal lip 42 tends to rise. The present configuration enables the seal portion 42a to be pressed onto the valve seat 34 and to keep the seal portion 42a in contact with the valve seat 34. Thus, the present configuration enables to restrict pressure from leaking at a negative pressure less than the valve opening pressure.

### Modification

In the above-described example, the relief valve device 1 of the embodiment is used for the tank sealing valve 2. The present disclosure is not limited to the embodiment. The relief valve device 1 may be used for a device, which is other than the tank sealing valve 2 and requires the positive-pressure relief valve 20 and the negative-pressure relief valve 21.

In the above-described example, the relief valve device 1 of the embodiment includes the two relief valves including the positive-pressure relief valve 20 and the negative-pressure relief valve 21. The present disclosure is not limited to the embodiment. The configuration of the disclosure may be employed simply in a relief valve.

As described above, the relief valve according to the present disclosure includes the valve element and the seal lip. The valve element is configured to open and close the hole according to the pressure in the pressure chamber. Fluid is introduced into the pressure chamber. The hole communicates with the pressure chamber. The seal lip is in an annular shape and equipped to the valve element. The seal lip is configured to make contact tightly with the valve seat when being in the valve-close state. The valve seat surrounds the hole. The seal lip is inclined toward the inner circumferential periphery of the hole. The seal lip is projected from the valve element toward the valve seat.

In the present configuration according to the present disclosure, the seal lip is inclined inward. Therefore, even when the pressure in the pressure chamber causes a deformation to expand the seal lip outward when being in the valve-close state, the deformation causes the seal lip to deform in a direction to make pressure-contact with the valve seat. Accordingly, even when the seal lip deforms in the valve-close state, the present configuration restricts pressure leakage.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A relief valve comprising:
a valve element configured to open and close a hole, which communicates with a pressure chamber, according to a pressure in the pressure chamber, the pressure chamber being configured to receive fluid; and
a seal lip being in an annular shape and equipped to the valve element, the seal lip configured to be in contact tightly with a valve seat, which surrounds the hole, when being in a valve-close state, wherein
the seal lip is inclined toward an inner circumferential periphery of the hole and projected from the valve element toward the valve seat.

2. A relief valve device comprising:
two relief valves each being the relief valve according to claim 1, wherein
one of the two relief valves is a positive-pressure relief valve configured to open when the pressure in the pressure chamber increases to a pressure equal to or greater than a valve opening pressure on a positive-pressure side, and
an other of the two relief valves is a negative-pressure relief valve configured to open when the pressure in the pressure chamber decreases to a pressure equal to or less than a valve opening pressure on a negative-pressure side.
